(19) United States
(12) Patent Application Publication
(10) Pub. No.: US 2023/0066678 A1
(43) Pub. Date: Mar. 2, 2023

(54) Device, System and Method of Adaptive Autonomy with Sensor Swarming

(71) Applicant: Woods Hole Oceanographic Institution, Woods Hole, MA (US)

(72) Inventors: Jeffrey KAELI, Falmouth, MA (US); Erin FISCHELL, East Falmouth, MA (US)

(21) Appl. No.: 17/799,022

(22) PCT Filed: Feb. 22, 2021
(86) PCT No.: PCT/US21/18971

§ 371 Date: Aug. 11, 2022

Related U.S. Application Data
(60) Provisional application No. 62/979,146, filed on Feb. 20, 2020.

(51) Int. Cl. G01S 3/802

(52) U.S. Cl. CPC G01S 3/802

(57) ABSTRACT

A sensing and transmitting system and method of using same, including a plurality of acoustically transmitting sensor (ATS) devices having a sensor, a housing, and a transmitter that, together, converts a physical quantity of the fluid body into a responsive signal measurable over long distances underwater by a central receiving node. The node having a receiver or receiver array, a controller and typically a logger. The signals sent by the ATS are modulated according to the sensor's measured parameter and in a manner known to and decodable by the node. This system may further have an autonomous node and the modulated signals of the plurality of ATS may influence the behaviour of the node.

### CROSS-REFERENCE TO RELATED APPLICATION

This application claims benefit to U.S. Provisional Patent Application No. 62/979,164, filed Feb. 20, 2020, the disclosure of which is hereby incorporated by reference in its entirety.

### FIELD OF THE INVENTION

This invention relates to improving the autonomy of a vehicle in an unknown environment utilizing a plurality of unconnected sensors. More particularly, this invention relates to improving autonomous underwater exploration with the use of a swarm of simple sensors each capable of transmitting information in a signal through the underwater environment with a property of that signal changed relative to information.

### BACKGROUND OF THE INVENTION

A common problem in underwater and oceanographic science is that many properties in the ocean must be directly observed. A large number of simultaneous direct measurements in the ocean can be collected, for example, using arrays of drifting floats. Near-real time data feeds from untethered (i.e., free-floating) sensors in the water column can also be transmitted. For example, an autonomous underwater vehicle (AUV) equipped with an acoustic modem may receive multiple signals from the free-floating sensors. However, there is currently no system capable of making a large number of simultaneous direct measurements of the ocean and providing those measurements back in real time.

A sensor relies on a transducer, a component that converts physical quantities into electrical signals and vice versa. These signals are then stored, processed, or transmitted to a different component or location. Oceanographers commonly use transducers to make measurements (e.g., temperature and pressure) when they physically deploy sensors in the ocean. However, the raw electrical signal output from these transducers cannot be transmitted over significant distances though the water column due to the high attenuation of electromagnetic radiation in water. The issue of “getting the data back” is currently solved either by (1) converting the electric signals into acoustic signals, since sound travels quite well through the water, or by (2) waiting until the sensor comes to the surface and transmits its data to a satellite or is physically recovered.

It is therefore desirable for a system to provide many sources of data from physical sensors disturbed throughout a fluid body (e.g., the ocean) back to a central source in real-time. An innovative sensing platform is disclosed herein that converts a property of a fluid body directly into an acoustic signal for transmittal of data in real-time to a central source. In addition, the real-time transmission may be used to improve the autonomy (i.e., function) of the central source, which is often an autonomous underwater vehicle (AUV).

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

One aspect of the present invention is a system for responsive communication and sensing in a fluid body, the system having a device and a node. The device has a sensor, a housing, and a transmitter. The sensor may measure a parameter of the fluid body in which it is in, the sensor producing measurement data; the housing creates a housing interior that excludes the fluid body environment; and the transmitter is located at least partially within the housing interior, it is informationally connected to the sensor, and it is configured to emit signals into the fluid body and to change at least one property (e.g., frequency) of the signals, the changed property being relative to the measurement data. The node has a first receiver, and a controller; the first receiver is configured to detect signals in the fluid body and the receiver produces first signal data, the controller is informationally connected to the first receiver and is configured to determine the at least one changed property of the signal data.

In some applications, the node's controller determines the sensor's original measurement in the at least one changed property of the signal data. In some applications, the node's controller determines a first angle of arrival of the first signal data. In some of those situations, the node also has a second receiver informationally connected to the controller and is configured to detect signals in the fluid body thereby producing second signal data; and the node's controller is further configured to determine a second angle of arrival of the second signal data. Additionally, in some of these situations, the node's controller is configured to compare the first and second angle of arrival (of the first and second signal data, respectively) to estimate a bearing between the node and the device. In some embodiments the above first and second receiver (of the node) are in a receiver array.

In some cases, the node in the above system has a logger informationally connected to the controller and is configured to store data received by the controller. In other cases, the device in the above system has a logger informationally connected to the sensor and is configured to store measurement data. In some embodiments, the node in the system has a propulsor configured to move the node through the fluid body. In some cases, the system also has a second device configured as the device in the system described above and configured to emit second signals into the fluid body with the second device's transmitter. In these cases, the node is configured to detect the second signals, producing second signal data. In some cases, the system has a second node configured as the node in the system described above.

Another aspect of the present invention is a device for responsive communication, the device having a sensor, a housing, and a transmitter. The sensor is configured to measure a parameter in a fluid body, and the sensor produces measurement data. The housing excludes the fluid body environment, creating a housing interior; and the transmitter is located at least partially within the housing interior, it is informationally connected to the sensor, and the transmitter emits signals into the fluid body and the transmitter is configured to change at least one property (e.g., rate) of the signals, the changed property being relative to the measurement data. In some cases, the device has a logger informationally connected to the sensor and the logger is configured to store the measurement data. In some cases, the device has a receiver and a controller, the controller being informationally connected to the receiver and the transmitter while the receiver is configured to detect signals in the fluid body. In some of these cases, the device has a propulsor that may move the device through the fluid body; the propulsor being informationally connected to the controller. In some cases, the device has a second sensor connected to the transmitter and configured to measure a second parameter of the fluid body, producing second measurement data, wherein the transmitter is configured to change the first property of the signal relative to the second measurement data. In some cases, the device further includes a timer informationally connected to the transmitter and configured to provide timing information to the transmitter; wherein the transmitter selects one of the first or second measurement data for the changed first property of the signal based on the timing information. In some cases, the device has a controller informationally connected to the sensor, the second sensor, and the transmitter and is configured to select the measurement data for the at least one changed property of the signal.

Another aspect of the present invention is a method of responsive communication in a fluid body, the method comprising the steps of (a) providing a device as first described above; (b) providing a node as first described above; (c) detecting, with the device's sensor, a parameter of the fluid body, producing a data measurement; (d) emitting a first signal into the fluid body, with the device's transmitter, with at least one property of the signal changed relative to the data measurement; (e) detecting the first signal with the node's first receiver which produces a first signal data; and (f) determining, with the node's controller, the at least one changed property of the first signal data.

In some uses, the method includes the step of (g) determining, with the node's controller, a first angle of arrival of the first signal data. In some of these uses, the node has a second receiver informationally connected to the node controller, and the step of (h) determining, with the node's controller, a second angle of arrival of the second signal data. In some of these uses, the method includes the step of (i) determining, with the controller, a bearing between the device and the node by comparing the first and second angles of arrival. In some uses the method uses a device also having a controller and a receiver informationally connected to the device controller and configured to detect signals in the fluid body and the node has a transmitter configured to emit transmission into the fluid body. In some of these uses, the method includes the steps (j) emitting. with the node transmitter, a transmission into the fluid body; (k) detecting, with the device receiver, the transmission, which is then referred to as a received transmission; and (l) adjusting a navigational course of the device based on the received transmission. In some uses the navigational course adjustment is based on a property of the received transmission. In some uses, the property is doppler shift as compared to an emission frequency, known to the device. In some of these uses, the method further includes the step of (m) estimating range between the device and the node with the device controller, based on the received transmission. In some uses, the method includes the step of (n) estimating range between the node and the device with the node controller, based on the first signal data.

In some uses, the method further includes the steps of providing a second device, the second device configured as described above and configured to emit second signals into the fluid body with the second device's transmitter; detecting, with the node first receiver, producing a second signal data; and determining, with the node controller, at least one changed property of the second signal data. In some uses, the method includes a node having a propulsor configured to move the node, and the step of moving the node toward the source of the first signal data, based on the determined angle of arrival of the first signal data. In some uses, the method includes the step of comparing the at least one changed property of the first and second signal data; and moving the node towards the source of one of the first or second signal data. In some uses, the method uses a device with a second sensor configured to connected to the transmitter and configured to measure a second parameter of the fluid body, producing second measurement data, and the step of selecting, between the measurement data and the second measurement data, producing a selected data measurement, and wherein step (d) uses the selected data measurement in place of the measurement. In some uses, the device further includes a timer informationally connected to the transmitter and configured to provide timing information to the transmitter; and the step of selecting, with the transmitter, one of the measurement data or the second measurement data for the changed first property of the signal based on the timing information. In some uses, the device has a controller informationally connected to the sensor, the second sensor, and the transmitter and the step of selecting, with the controller, the measurement data for the at least one changed property of the signal.

### BRIEF DESCRIPTION OF THE DRAWINGS

In what follows, preferred embodiments of the invention are explained in more detail with reference to the drawings, in which:

FIG. 1 is a schematic representation of the components of a representative ATS devices transmitting through a fluid body to a central receiver node.

FIG. 2 depicts a temperature gradient (i.e., a parameter gradient) in a fluid body as a grey gradient with a system arrayed in a three-dimensional swarm throughout the gradient; each ATS device of the system transmits into the fluid body, transmitting at a frequency dictated by the measured local temperature, depicted as a numbered frequency (k); two central receiving nodes follow the plurality of ATS devices monitoring the environment for the signals.

FIG. 3 depicts a second embodiment having an ATS device 101b having an attachment mechanism 120.

FIG. 4 depicts estimates of ATS devices locations and GPS locations of a central node according to one embodiment.

FIGS. 5A and 5B shown range and bearing, respectively of ATS devices to a central node according to one embodiment.

FIG. 6 schematically illustrates one exemplary responsive communication method according to the present invention.

FIG. 7A shows the estimated heading as a function of acoustically-estimated vs ground truthed IMU measurement, and FIG. 7B shows the error associated with the estimates.

FIG. 8 schematically illustrates a second exemplary responsive communication method according to the present invention.

### DEFINITIONS

The term “frequency” is used herein to mean its standard definition, that is the speed or rate of oscillation or vibration measured in cycles per second, known as Hertz (Hz). The term “frequency” is not to be confused with the term “rate” as used herein. The term “rate” is used herein to describe the number and timing of signals emitted from a transmitter. A rate would be known in the art as the frequency of signals, but for clarity the word ‘frequency’ will not be used herein to describe a rate of multiple signals.

The term “responsive signal” as used herein refers to the ability of an ATS device to change at least one property of a signal by the transmitter, and for that change to encode information about the sensor's measurement. The central node then decodes the responsive signal to obtain the information as measured by the sensor.

### DETAILED DESCRIPTION OF THE PRESENTLY PREFERRED EMBODIMENTS

### Overview

This invention may be accomplished by a providing a system 100 having a plurality of acoustically transmitting sensor (ATS) devices 101 and at least one central receiving node 102 for use in a fluid body FB. Each ATS device 101 having a sensor 103 to measure a parameter 104 in the fluid body, a housing 105 to protect the device and its components from the fluid body, and a transmitter 106 to create a responsive transmission (referred herein as a signal) 107 capable of traveling through the fluid body, the signal 107 having a property that corresponds to the measured parameter 104 (e.g., signal frequency changing with measured parameter change).

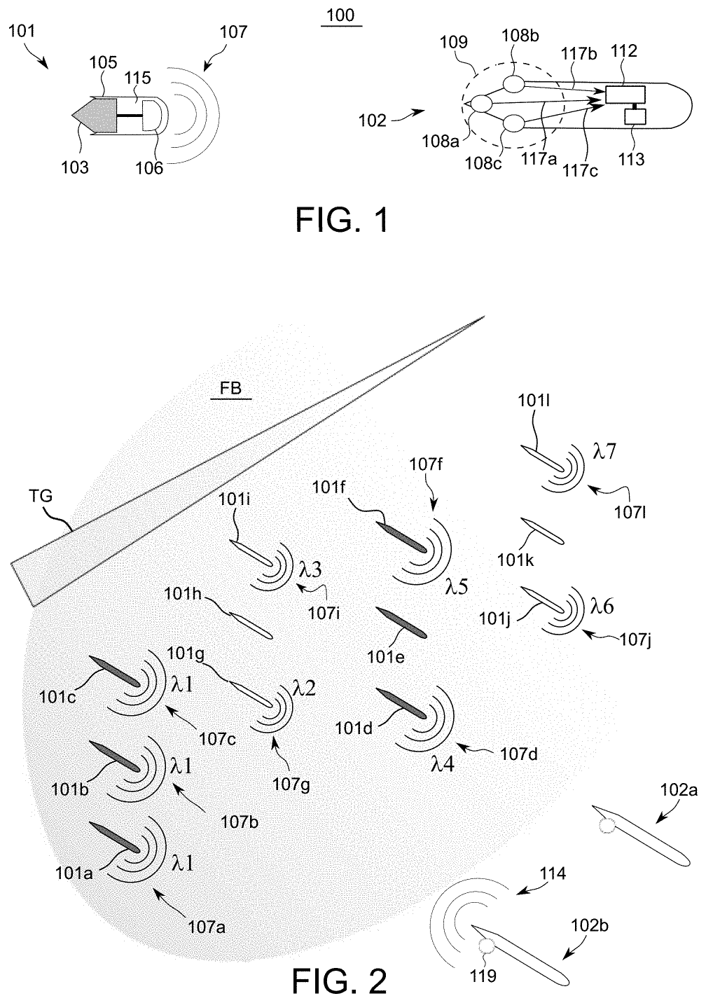

As depicted in FIG. 1, the system 100 encompasses an ATS device 101 that directly converts a physical quantity first into a signal (e.g., an acoustic signal) 107 that is measurable over long distances underwater by a central node 102. This signal 107 can be detected by a receiver 108 and converted to signal data 117 for subsequent storage, processing, or further transmission. Notably, receiver 108 can be quite far away from the ATS device 101, enabling the real-time (relative to the speed of sound) remote observation of a quantity in the fluid body. Furthermore, a swarm of ATS devices can be deployed in an area of interest (AOI) and their acoustic signals received by a single central receiver node 102. The central receiver node is referred to herein as simply as node 102. The detected signal data 117 is then processed by the node 102 to determine the original sensor measurement data as determined by the ATS device 101 as well as the angle of arrival of signal 107 to receiver 108.

One realization of the present invention is the responsive signal 107, that changes a property of the signal (e.g., the frequency of an acoustic signal) as a function of a measured parameter 104 (e.g., temperature) in the fluid body (e.g., the ocean); typically, the signal encodes no further device 101 identification information. ATS devices 101 may be produced cheaply and in high volumes. A large network of drifters or AUVs equipped as ATS devices 101 may be deployed in an AOI, and each device 101 may be programmable to ping (i.e., emit signal 107) independently as a function of its local observed and measured parameter 104. A single node 102 equipped with a receiver array 109 or receiver 108 can measure both the frequency as well as the angle of arrival of the signals 107 from the plurality of ATS devices 101.

### ATS Device 101

The present invention provides for a plurality of an acoustically transmitting sensor ATS devices 101 for measuring the parameter of interest in the surrounding fluid body FB and transmitting it to the central receiving node 102. Typically, an ATS device 101 comprises a housing 105, a sensor 103, and a transmitter 106. Typically, the housing 105 is a pressure housing that excludes the fluid body (e.g., water). The housing 105 creates a housing interior 115 that is excluded and protected from the fluid body FB. Typically, at least a part of the transmitter 106 is protected (e.g., in housing interior 115 or potted in a mechanically protecting housing) from the fluid body FB conditions (e.g., pressure, conductive liquid, corrosion, and the like) by the housing 105.

The transmitter 106 may be any suitable means as known in the art and may vary depending on the embodiment. The transmitter 106 emits or otherwise sends signals 107 through the fluid body FB. For most embodiments, the transmitter 106 emits acoustic signals and those signals are responsive signals 107, such that one or more properties of the signal 107 are modifiable by the transmitter 106. In the currently preferred embodiment, the transmitter 106 is a commercially available acoustic transmitter. In other, less preferred embodiments the transmitter 106 is optically based. Range of signals 107 depends on transmitter 106. In some embodiments, transmitter 106 emits acoustic signals 107 in a range of at 20 to 50 kHz. Typically signals 107 have a range of 1 km, a range of 2 km, a range of 3 km.

The sensor 103 of an ATS device 101 may be any suitable sensor as known in the art. In the currently preferred embodiment, the sensor 103 is temperature probe suitable for underwater use. Sensor 103 measures a parameter 104 of the fluid body FB in which the ATS device 101 is situated. The sensor's output is referred herein as measurement data 116. The sensor 103 is informationally connected to the transmitter 106. The ATS device 101 is configured to acoustically transmit the sensor's measurement data 116, or a portion of the sensor's measurement data 116, via the transmitter 106 as signal 107 into the fluid body FB. The sensor 103 preferably drains very little power. Typically, the sensor 103 requires only 1 W, preferably less than 1 W, approximately 0.5 W, approximately 0.1 W, or less than 0.1 W. In some embodiments, each ATS device 101, or a subset of the plurality of ATS device 101 may have more than one sensor 103, each connected to the transmitter 106. In devices 101 with more than one sensor, transmitter 106 may have predefined times or conditions to send signals 107 encoding measurement data 116 from different sensors. In these cases, node 102 would also be programmed to know when transmitter switched between sensors, and the transmitter 106 has the ability to select between the measurement data 116 of all sensors 103 present. Sensor or sensors 103 may be either an analog sensor or a digital sensor.

An ATS device 101 may further include additional components. In most embodiments the ATS device 101 further comprises a logger 110 (e.g., a digital data storage mechanism) informationally connected to at least the sensor 103, enabling the sensor's measurement data to be stored on the ATS device 101. Logger 110 enables storage of all or almost all of the sensor's measurement data 116 while only a subset of measurement data 116 can be sent to the node 102 as signals 107. Most often a simple digital controller 111 is included with the ATS device 101 to accept programming of the ATS's behavior. The controller 111 are typically programmed before deployment. In a few embodiments, an ATS device 101 (via transmitter 106 or an ATS device receiver 118) accepts two-way signals between it and a node 102, and controller 111 may be programmed by the node transmissions 114. Controller 111 is most often informationally connected to sensor 103, logger 110 and transmitter 106. An ATS device 101 may have additional sensors. Typically, the additional sensors are informationally connected to at least the transmitter. Additional components include a power source, a timer, and a propulsor. In some embodiments, an ATS device 101 with a second sensor also comprises a timer. The timer, which may be any timer mechanism as known in the art, produces timing information and enables the transmitter to select measurement data from one of the two (or more) sensors for encoding the changed property of the responsive signal 107. In some embodiments, the timer is incorporated into the device controller 111. The propulsor 122 enables an ATS device 101 to move through the fluid body and is most often informationally connected to controller 111. Propulsor 122 may be any suitable propulsion mechanism as known in the art, including by not limited by a propeller, a mass-shifter, a buoyancy engine, a sail, and passive drifting.

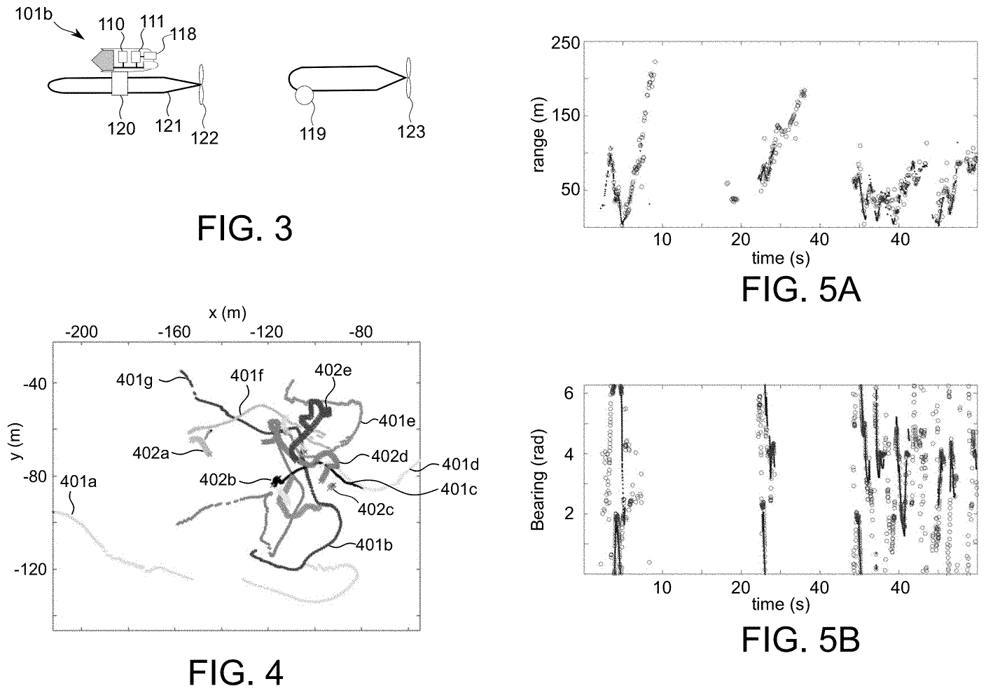

It is within the scope of the present invention for the ATS device 101 to be a standalone device, with the components described above; for example, an ocean drifter. The ATS device 101 may also have further components to make it mobile, for example a wind sail, a motor and propeller, a buoyancy engine, and the like. In these embodiments the ATS device may be thought of as an integrated component in a larger system. In some embodiments the ATS device has an attachment mechanism 120 that enables it to be secured to another device 121, for example an AUV. In these embodiments, illustrated in FIG. 3, the ATS device 101b typically has its own housing 105, with additional power and information connections, as known in the art. These connections enable the ATS device 101b to interface with a controller on the attached device, for example a front seat or backseat controller in an AUV. The ATS device 101b could then inform the attached device of at least the measurement data 116. Additional functions (e.g., data logging) could then occur on the attached device and not the ATS device 101b.

### Responsive Signal 107

The transmitter 106 on an ATS device 101 is further programmed to change the emitted signals 107 in response to the measurement data 116 produced by the sensor 103, referred herein as responsive signals (but generically referred to as signals 107 herein for simplicity). Typically, signals 107 involves a change in how the signal is produced and therefore a change in at least one property of the signal 107. The altered signal 107 property is relative to the sensor's measurement data 116. The altered property of signal 107 is also referred herein as a changed property of signal 107. Typically, the change in the signal property is pre-set before system deployment such that the node 102 properly decodes the responsive signal 107. Several possible examples of a responsive signal will be described presently herein. In some embodiments, signal 107 may have more than one changed property (i.e., more than one of the presently described examples).

In the currently preferred embodiment, signal 107 frequency is changed when the sensor 103 detects a change in the measured parameter 104. This changed frequency is depicted in FIG. 2, where the parameter 104 is temperature, and ATS devices 101a-1 are moving through a fluid body FB and experience a temperature gradient TG. Temperature gradient TG is depicted as a shaded backdrop as well as the triangle labelled TG. ATS devices 101a-c detect one temperature and transmit signals 107a-c at a first frequency 1, whereas device 101g measures a different temperature (i.e., parameter 104) and transmit a signal 107g at a different, second frequency λ2. Likewise, FIG. 2 depicts a third through seventh measured temperatures by additional ATS devices 101i-1 and each differently measured temperature results in a differently transmission frequency λ3-7. FIG. 2 is for exemplary purposes only; the numbers are arbitrary, the frequency shift is fully customizable, and the parameter 104 may be any measurable property of the fluid body FB.

A second example of a responsive signal 107 is a signal that comprises a frequency sweep; a continuous signal where the frequency emitted increases or decreases with time (often logarithmically). In a frequency sweep signal, the information is encoded over multiple frequencies making the signal 107 more robust against background noise. A responsive frequency sweep may comprise different start and stop frequencies or different time periods and rate of frequency change from start and stop frequencies. One example of a frequency sweep signal 107 is a sweep starting at 25 kHz, ending at 27 kHz, and having a 2 kHz bandwidth centered at 26 kHz.

A third responsive signal 107 example is the rate of signal emission. A plurality of ATS devices 101 may all send the same signal 107 (i.e., the same sound frequency emitted), and the rate at which they are emitted from the ATS device 101 may depend on the sensor's measured parameter 104. A fourth responsive signal 107 example is a system using shift keying, for example binary phase shift keying. Shift keying is a modification scheme that conveys data by changing at least two different phases of a signal 107. One modulation may be multiplying a sinusoidal signal by a binary sequence (e.g., either 1 or −1) to spread the information over multiple frequencies in a way that can be easily decoded.

The degree of differences of the responsive signal 107 (e.g., a change in frequency) is situationally dependent and most preferably is set before deployment of a system 100. Most often the exact degree of change depends on the number of ATS devices 101 in a system 100 and the expected range of the parameter 104. A larger expected parameter range in a fluid body FB dictates smaller changes in the responsive signal 107. One advantage of the responsive signal 107 and the system 100 overall is that responsive signals 107 enable the signals not to require an identifying sequence or other identifying property. Acoustic transmissions known in the art require some sort of identification system, for example an ID sequence or binning into pre-set frequency ranges or times. An identification requirement greatly reduces the ability of known systems to act in a swarming behaviour, unlike the current invention.

In some embodiments, separate ATS devices 101 are programmed to emit signals within a predefined bandwidth of frequencies. For example, a system 100 with five ATS devices 101a-e, each device 101 may emit a signal 107 in 10 kHz bandwidth range (for example in bandwidths of 10-20 kHz for device 101a, 20-30 kHz for device 101b, 30-40 kHz for device 101c, 40-50 kHz for device 101d, and 50-60 kHz for device 101e). Within each bandwidth the signal 107 then changes according to the measured parameter 104. For example, an elevated temperature measurement corresponds to an increased frequency of 0.5 kHz, changing for ATS device 101a signal of 15 kHz to 15.5 kHz. Allotting different bandwidths to different devices shortens the amount of possible signal 107 change for each device 101 and limits the number of devices 101 in a system 100; however, this enables simpler signal processing, especially in embodiments where the node 102 has a device 101 tracking system (e.g., a USBL positing system). Alternatively, devices 101 have pre-programmed movement tracks in 3D and these tracks are programmed into node controller 112 such that node 102 knows where each device 101a-e will be located during operation.

### Central Receiving Mode 102

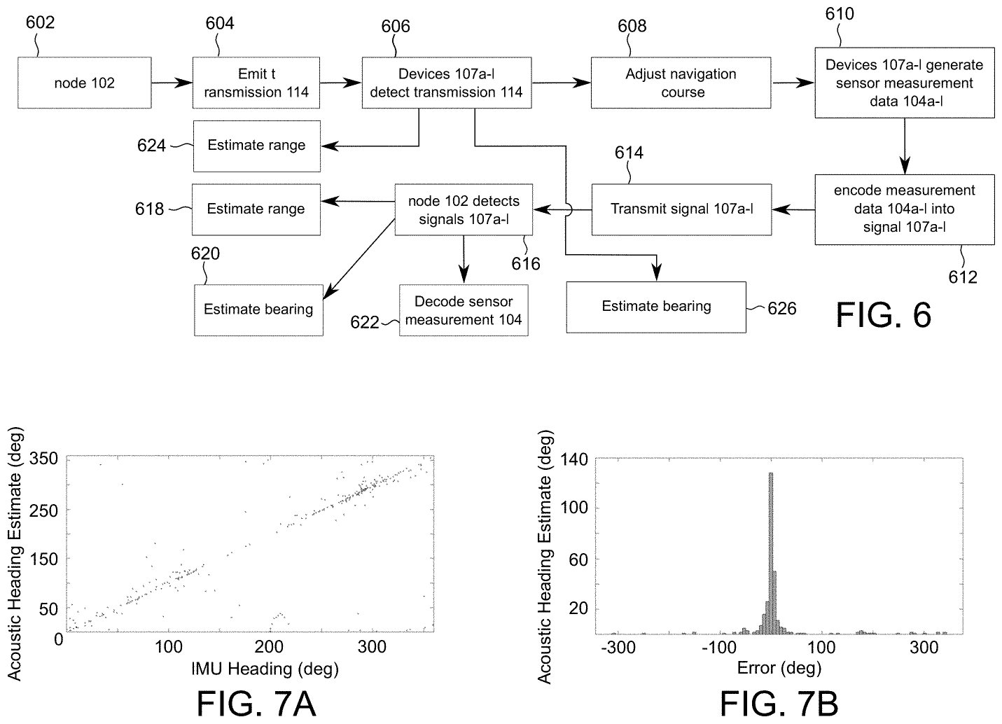

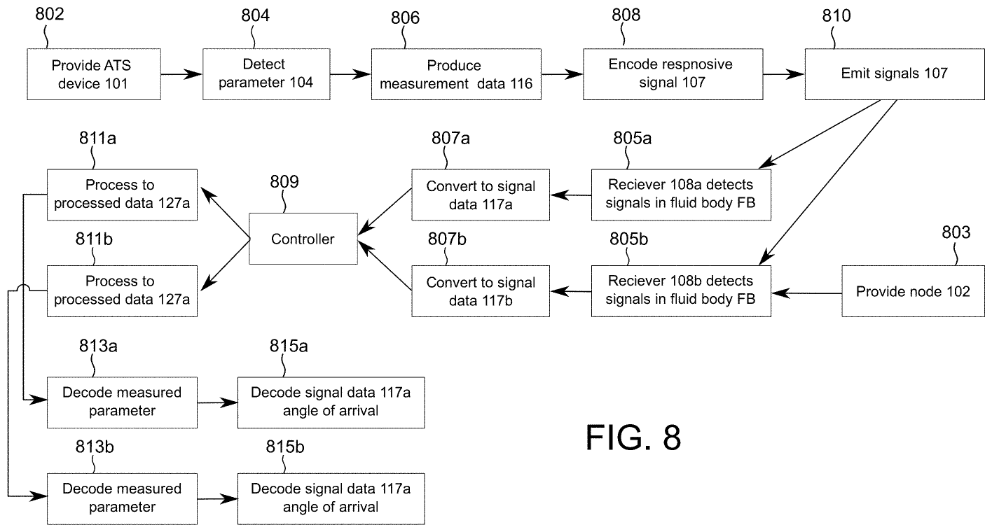

The present invention provides at least one central receiving node 102 that receives or otherwise detects signals 107 from each ATS device 101. The node 102 comprises a receiver 108 or receiver array 109, and a node controller 112. In most embodiments, node 102 comprises a node logger 113, and a transmitter 119. The node 102 receives and decodes signals 107 from each ATS device 101, typically for further action. Most often, the node 102 may navigate towards an area of elevated parameter 104 (e.g., temperature) as measured by an ATS's sensor 103. In some cases, a node 102 may send additional signals to other vehicles (e.g., a surface ship) or localities (e.g., a home base). In these cases, node 102 has a transmitter 119 that emits transmissions 114. Transmissions 114 may target other vehicles or may communicated back to ATS devices 101. Transmissions 114 detected by an ATS device 101 are referred herein as received transmissions. In some embodiments, node 102 and ATS devices 101 have two-way communications and may be programmed to have time windows which are assigned to device 101 or node 102. In some cases, an ATS device 101 does not send signals 107 till after transmission 114 is received. In these embodiments, the amount of communication from ATS device 101 to node 102 is decreased, but two-way travel time allows node 102 to estimate range between device 101 and itself (illustrated in FIG. 6). Often times ATS device 101 may adjust its navigation course in response to the received transmissions. In many embodiments, node 102 also has a propulsor 123. Propulsor 123 enables the node 102 to move or take other actions often in response to signals 107. Node propulsor 123 may be any suitable propulsion mechanism as known in the art, including by not limited by a propeller, a mass-shifter, a buoyancy engine, and a sail.

In some cases, a node 102 may be a human occupied vehicle (HOV), or a remotely operated vehicle (ROV) with a human controller in the loop. In these cases, the operator may instruct the node 102 to take an action, for example navigating to a location of elevated measured parameter. The node (either autonomously or by an operator) may instruct another vehicle to take the action. To facilitate communications and other actions, node 102 often has a transmitter 119 configured to emit transmissions 114 into the fluid body. Transmissions emanating from node 102 are referred as transmissions 114 herein to differentiate from ATS device 101 signals 107.

In some cases, a system 100 may have more than one node. For example, and as illustrated in FIG. 2, a system 100 has two nodes 102a and 102b. Both nodes 102a and 102b receive signals 107 through the fluid body FB from the plurality of ATS devices 101a-1. Node 102a and 102b may act independently of each other, however it is typically preferred for nodes 102a and 102b to act in concert. One node 102a may take the action as described above while node 102b follows on a predetermined path. Node 102a and 102b may further have different capabilities (e.g., one ROV with manipulation tools).

A receiver 108 is configured to detect signals 107 as they travel through the fluid body FB. The receiver 108 produces machine-readable information or data; this information is referred herein as signal data 117. In many embodiments, multiple receivers 108a-c are in a receiver array 109. Each receiver is informationally connected to the controller 112. A receiver array 109 enables the node 102 to calculate angle of arrival for each detected signal; detected signals converted into signal data 117a-c are depicted as arrows 117a-c in FIG. 1. Each receiver 108 may be any suitable receiver as known in the art.

The controller 112 is informationally connected to all present receivers 108, enabling the controller 112 to receive the signal data 117 for processing. In embodiments with a receiver array 109, each receiver 108a-c is informationally connected to the controller 112 such that the controller receives signal data 117a-c from each receiver 108a-c, respectively. The controller 112 calculates or otherwise processes signal 107 angle of arrival by comparing the signal data 117a-c from each receiver 108a-c of the receiver array 109 and by beamforming. Signal data 117 processed by controller 112 is referred herein as processed data 127. Controller 112 may also further save the received signals on the logger 113.

Typically, the controller 112 processes and compares signal data 117a-c from each receiver 108a-c in a receiver array 109 to estimate a precise angle of arrival of signals 107 and therefore bearing between the receiver array 109 and the transmitter 106 (and therefore the node 102 and the ATS device 101). The calculations used to determine the angle of arrival may be any suitable calculations as known in the art. In the currently preferred embodiment, a plurality of receivers 108a-c produce a plurality of processed signal data and controller 112 performs beamforming calculations to determine signal 107 angle of arrival. The controller 112 then also compares the plurality of signal data 117 to the predetermined changed property for signals 107. Processed signals allow the node 102 to decode the responsive signals 107 and act on the data coded into the signals 107. For example, an embodiment may have a predetermined shift of 10 Hz for every one degree Celsius change from a baseline temperature of 17 degrees C. and signal frequency of 10 kHz. A signal 107 having a frequency of 10.15 kHz would result in a processed signal informing the node 102 that a temperature of 32 degrees Celsius was detected at a certain bearing by at least one ATS device 101. A second example, an embodiment may have a baseline temperature of 0 C which is represented by a frequency sweep centered at 26 kHz; a temperature of 23 C is represented by a sweep centered at 49 kHz. A receiver 108 detect signals 107 in the range of 25 to 50 kHz with a resolution of 1 kHz. In this embodiment, 24 different 2 kHz bandwidth sweep signals are possible and discernible by the receiver 108, centered between 26 to 49 kHz and spaced every 1 kHz; making a system 100 that resolve temperatures from 0 C to 23 C at 1 C resolution.

The node 102 detects incoming signals 107 from the plurality of ATS devices 101 in real-time and all signals from each ATS device 101 are transmitted simultaneously. That is, each ATS device 101 does not have a time window for which it is the only device 101 emitting signal 107. Therefore, many more ATS devices may operate in an AOI as compared to standard, known in the art transmission schemes. The node 102 enables the resolution of each independent ATS device 101 by way of the receiver array 109 and beamforming.

Typically, the information encoded in the signals 107 is used by the node 102 or by an interconnected device (i.e., an AUV) to inform autonomy decision making. For example, if an AUV is tasked with seeking out hot spots, the AUV will navigate in the direction of ATS devices 101 that send responsive signals 107 indicating a higher temperature (e.g., by increasing transmission frequency).

### Parameter of Interest

The present invention is directed towards measuring and recording at least one parameter of interest in a fluid body FB. The parameter may be any measurable characteristic of a fluid body FB. Including, but not limited to, temperature, pressure, conductivity, fluid velocity, turbidity, fluorescence, presence of solutes, and the like.

### Averaged Response

The present invention enables the system 100 such that each AST device 101 does not have to be independently resolved or tracked by the node 102, instead node 102 may be programmed to monitor signals 107 to gather an averaged response (i.e., a general image) from the surrounding environment. In other situations, the node 102 may be programmed to average responses from a subset of the plurality of ATS device 101, typically by signal 107 angle of approach. Such averaged response of multiple signals 107 results in what is referred herein as a ‘low-resolution snapshot’ and this enables adaptive behaviours of the node 102. In some situations, the node 102 may send command transmissions 114 to a network of vehicles (e.g., AUVs) based only on a subset of data from sensor 103, while a complete raw dataset (including sensor measurement data, as well as other data generated on device 101) is available after all assets (i.e., the ATS devices 101) are recovered. In this way, a system 100 can be used to close the loop on swarming autonomy and enable simultaneous wide area and real time observation of the ocean.

One example of averaged response builds off the situation depicted in FIG. 2. An AUV acting as a node 102a may be programmed to seek out areas of high temperature. By following a plurality of ATS devices 101a-1, the AUV node 102a may navigate towards a region which one or more ATS devices 101 report higher temperatures via their responsive signals 107. The direction the AUV node 102a chooses can be determined by an averaged response of a plurality of signals 107, and not towards a single ATS device 101. In this example node 102a may average responses from elevated sensor measured parameter 104 resulting from decoding signals 107a-i, which have frequencies λ1-3, moving in a direction that averages the angle of arrival of signals 107a-i.

### EXAMPLE

One embodiment will be presently discussed. This embodiment is designed to close the loop with autonomy as a feedback loop, and is meant to be an adaptable, scalable swarm of sensors (ATS devices 101) with a node 102. This embodiment is directed towards sampling a large area of ocean, for example a cubic kilometre at 100 m resolution. There are many relevant processes at this 100 meter scale, for example, internal waves, currents and plumes. The sampling must also be in situ for certain measurements, for example biological and chemical measurements. A traditional measurement system would utilize an oceanographic research ship, making 100 casts in the cubic kilometre AOI, each cast taking an hour, resulting in a sampling time of greater than 4 days. A typical AUV system would have a track length of 1000 m at 10 depths, and 10 lengths through the AOI for a total track length of 100 km at 2-3 knots, resulting in a sampling time of approximately a day. The relevant processes that we wish to measure change on a faster basis than the above measuring times. However, using currently available systems, for example doubling the number of AUVs would only halve the measurement time while doubling the cost. Therefore, a desirable solution would be to use a swarm of low-cost systems for fast and efficient measurements.

A hurdle to swarming systems is that two-way communications scale exponentially with the number of vehicles and commination latencies scale linearly with the number of vehicles. These scaling problems affect both vehicle cost and communication bandwidth. Swarming costs may be affected by utilizing an external nav reference (e.g., a beacon). Two-way communication travel time can be used for range determination, and a receiving array on the vehicle can be used to determine bearing, but this system still requires two-way communications, and latency is still a problem. One-way communications may be used in conjunction with very accurate clocks (e.g., chip scale atomic clocks, abbreviated CSAC) and different pinging regimens may be used to code for different behaviors.

By using the same external nav reference, multiple vehicles can scale for navigation, without requiring each vehicle to know what the others are doing. Pre-programing the multiple vehicles prevents collisions. But this system would not be adaptive. For the multiple vehicles to form an adaptive swarm, each vehicle (i.e., an ATS device 101) would need to communicate back to a leader or central node 102. Therefore, each vehicle 101 has a sensor 103 and that sensor broadcasts its measured parameter 104 into the ocean with a responsive signal 107. Now the leader node 102 knows what each of the multiple device 101a-1 (i.e., follower vehicles) is sensing and the leader node 102 can adapt its mission plan accordingly. This results in a decentralized command and control and sensing scheme. Sensor 103 broadcasts (i.e., signals 107) may be done with navigation ping and can code for different sensors or different sensor measurements. There is no need or requirement to independently identify each vehicle, instead only transmit a portion of sensor measurement data 116. The central node 102 only must sense the plurality of signals 107. Sensing resolution of data depends on signals 107 used and spatial resolution of data depends on receiver array 109 characteristics of the central node 102.

In this example, as illustrated in FIG. 6 one measurement cycle comprises the steps of (a) leader node 102 emit a node transmission 114 (e.g., a navigation ping) into the fluid body FB (step 604), (b) the multiple ‘followers’ devices 101a-1 detecting that node transmission 114 (with ATS receiver 118; step 606), (c) each follower device 101 adjusts its own navigation course based on the received node transmission 114 (step 608); in this example, each the device 101 adjusts based on the degree of doppler shift of transmission 114 such that device 101 maintains a position relative to leader node 102. Doppler shift is detailed in PCT patent application PCT/US20/54226, incorporated in its entirety by reference herein. Next, in step (d) follower devices 101a-1 generate sensor measurement data 116a-1 from each device's sensor (step 610), (e) encode sensor measurement data 116a-1 into a responsive signals 107a-1(step 612), and (f) transmit signals 107a-1 into the fluid body (step 614).

Next, step (g) the leader node 102 detects the plurality of responsive signals 107a-1 (while constantly monitoring for signals; step 616 in FIG. 6), (f) the leader node 102 estimates range from two-way signal travel time (combining one-way travel time of transmission 114 and signal 107; step 618 in FIG. 6), and (g) the leader node 102 estimates bearing from array beamforming of the received signals 107 and signal data 117 (step 620). The leader node 102 may further estimate a sensor value (i.e., measured parameter 104) by decoding the responsive signals 107 (step 622). Meanwhile the follower devices 101 may each estimate range from relative attenuation (step 624), estimate bearing from doppler shift and movement (step 626), and execute behaviour based on range, bearing and navigation ping (as detailed by PCT patent application

PCT/US20/54226).

In this embodiment, the leader node 102 is a JetYak, emitting node transmissions 114 as navigation pings of 7-9 kHz with a 20 ms up-chirp. The JetYak node 102 also has a linear receiver array 109 of 6 receivers 108 spaced 2.9 cm apart. The ATS devices 101 are SandShark AUVs, each SandShark having a magnetic compass, a PI-USBL (passive inverted ultra-short baseline) acoustic positioning system, a CSAC, and an acoustic micromodem (here the transmitter 106), as known in the art. The magnetic compass has a heading mapped to 191 possible signals with less than 2 degrees resolution, the PI-USBL in conjunction with the CSAC has a 5-element array that was used as a ground truthing mechanism, and the micromodem has a 2 kHz bandwidth and up-chirps centered from 22.5 to 32 kHz (spaced at 50 Hz). It is to be understood that some components in this example have more capabilities than required by the present invention; for example, an acoustic micromodem is not required to perform the invention and that a pinger may suffice.

FIG. 4 depicts an AOI of the leader node 102, shown in crosses as thick lines 402a-e, as well as GPS locations of follower devices 101, shown in dots as thin lines 401a-g, estimated locations. FIG. 5A depicts the ranges of Jetyak node 102 in grey open circles and SandShark follower devices 101 as small dark filled dots as a function of time. While FIG. 5B depicts the bearing of both Jetyak node 102 and SandSharks follower devices 101, again as a function of time. FIG. 7A compares the heading estimates of one SandShark follower device 101 as a function of measurements from the device 101 onboard inertial measurement unit, abbreviated IMU (x-axis), and the estimated heading (y-axis) by follower node 102, using the invention described herein.

FIG. 7B shows the error in degrees of the difference of FIG. 7A IMU measurements vs. estimated heading. Therefore, this example illustrates a truly scalable technique enabling realistic real-time 4D adaptive sensing in the ocean. This system is inexpensive due to its use of inexpensive components, including inexpensive propulsion, navigation (e.g., using a single hydrophone and using doppler shift and attenuation), and sensing by using off the shelf animal tag pingers, microelectromechanical systems (MEMs), and lab on a chip sensor. In this system, follower device 101 accuracy is kept within a box relative to the leader node 102 and overall system accuracy is dictated by the leader node 102 and the leader's receiver array 109. It is to be understood that the leader node 102 may be physically in front of (i.e., lead) or behind (i.e., follow) the follower devices 101, and that these terms are used for convenience only.

Although specific features of the present invention are shown in some drawings and not in others, this is for convenience only, as each feature may be combined with any or all of the other features in accordance with the invention. While there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps that perform substantially the same function, in substantially the same way, to achieve the same results be within the scope of the invention. Substitutions of elements from one described embodiment to another are also fully intended and contemplated. It is also to be understood that the drawings are not necessarily drawn to scale, but that they are merely conceptual in nature.

It is the intention, therefore, to be limited only as indicated by the scope of the claims appended hereto. Other embodiments will occur to those skilled in the art and are within the following claims.

1. A system for responsive communication in a fluid body, comprising:
a device comprising:
a sensor configured to measure a parameter of the fluid body, producing measurement data;
a housing configured to exclude the fluid body, creating a housing interior;
a transmitter located at least partially within said housing interior, informationally connected to said sensor, and configured to emit signals into the fluid body;
wherein said transmitter is configured to change at least one property of said signals relative to said measurement data, producing at least one changed property;
a node comprising:
a first receiver configured to detect signals in the fluid body, producing first signal data; and
a controller informationally connected to said first receiver and configured to determine said at least one changed property.

2. The system of claim 1 wherein said controller determines the measurement of said sensor in said at least one changed property.

3. The system of claim 1 wherein said controller is configured to determine a first angle of arrival of said first signal data.

4. The system of claim 3 wherein said node further comprises a second receiver informationally connected to said controller and configured to detect signals in the fluid body, producing second signal data, and wherein said controller is configured to determine a second angle of arrival of said second signal data.

5. The system of claim 4 wherein said controller is configured to compare said first and said second angle of arrival to calculate a bearing between said node and said device.

6. The system of claim 1 wherein said node further comprises a logger informationally connected to said controller and configured to store data received by said controller.

7. The system of claim 1 wherein said node further comprises a propulsor configured to move said node through the fluid body.

8. A device for responsive communication, comprising:
a sensor configured to measure a parameter of a fluid body, producing measurement data;
a housing configured to exclude the fluid body, creating a housing interior; and
a transmitter located at least partially within said housing interior, informationally connected to said sensor, and configured to emit signals into the fluid body;
wherein said transmitter is configured to change a first property of said signal relative to said measurement data.

9. The device of claim 8 further comprising a logger informationally connected to said sensor and configured to store said measurement data.

10. The device of claim 8 further comprising a receiver and a controller; said controller informationally connected to said receiver and said transmitter; and wherein said receiver is configured to detect signals in the fluid body.

11. The device of claim 10 further comprising a propulsor configured to move the device through the fluid body, informationally connected to said controller.

12. A method for responsive communication comprising the steps of:
(a) providing a device having:
a sensor configured to measure a parameter of the fluid body, producing a measurement;
a housing configured to exclude the fluid body, creating a housing interior; and
a transmitter informationally connected to said sensor, configured to emit signals into the fluid body and configured to change a first property of said signals relative to said measurement, creating a first changed property;
(b) providing a node having:
a first receiver configured to detect signals in the fluid body; and
a controller informationally connected to said first receiver;
(c) detecting, with said sensor, a parameter of the fluid body, producing measurement data;
(d) emitting a signal into the fluid body with a first changed property of said signal changed relative to said measurement;
(e) detecting said signal with said node first receiver, producing a first signal data; and
(f) determining, with said node controller, said first changed property.

13. The method of claim 12 further comprising the step of (g) determining, with said node controller, a first angle of arrival of said first signal data.

14. The method of claim 13 wherein said node further comprises a second receiver informationally connected to said node controller and configured to detect signals in the fluid body, and the steps of (h) detecting said signal with said node second receiver, producing a second signal data; and (i) determining, with said node controller, a second angle of arrival of said second signal data.

15. The method of claim 14 further comprising the step of (j) determining, with said controller, a bearing between said device and said node by comparing said first and said second angles of arrival.

16. The method of claim 12 wherein
said device further comprises:
a device receiver configured to detect signals in the fluid body; and
a device controller informationally connected to said device receiver and said transmitter; and
said node further comprises a node transmitter connected to said controller and configured to emit transmissions into the fluid body.

18. The method of claim 16 further comprising the steps of:
(k) emitting a transmission into the fluid body with said node transmitter;
(l) detecting, with said device receiver, said transmission, producing a received transmission; and
(m) adjusting a navigational course of said device based on said received transmission.

19. The method of claim 18 further comprising the step of (n) estimating range, with said device controller, between said device and said node based on said received transmission.

20. The method of claim 12 further comprising the step of (o) estimating range, with said controller, between said node and said device based on said first signal data.
